(19) United States
(12) Patent Application Publication
(10) Pub. No.: US 2005/0083394 A1
(43) Pub. Date: Apr. 21, 2005

(54) System, apparatus, and program for processing character information

(76) Inventors: Mamoru Sakai, Suwa-shi (JP); Hiroshi Ono, Tokyo (JP); Yoichi Hine, Tokyo (JP); Seiji Tanaka, Suwa-shi (JP)

Correspondence Address: LORUSSO, LOUD & KELLY, 3137 Mount Vernon Avenue, Alexandria, VA, 22305, US

(21) Appl. No.: 10/941,027

(22) Filed: Sep. 15, 2004

(30) Foreign Application Priority Data
Sep. 30, 2003 (JP) 340715

(51) Int. Cl. B41J 2/385

(52) U.S. Cl. 347/116

(57) ABSTRACT

The invention provides a system, an apparatus, and a program for processing character information, which have high versatility and are applicable to various types of small print producing apparatus registration functions. In the character information processing system of the invention, a small print producing apparatus having a function of producing and registering predetermined types of registration data and a character information processing apparatus are connected. In the character information processing apparatus, a character information processing program is incorporated in a computer. The character information processing apparatus includes a unit for capturing the registration data from the small print producing apparatus, a unit for supplying the registration data to the small print producing apparatus to register the registration data, and a unit for newly producing the registration data or correcting the registration data. The small print producing apparatus includes a unit for replying the registration data stored in the small print producing apparatus in accordance with a request to transmit the registration data and a unit for registering the supplied registration data in the small print producing apparatus.

### CROSS-REFERENCE TO RELATED APPLICATION

This application claims, under 35 USC 119, priority of Japanese Application No. 2003-340715 filed Sep. 30, 2003.

### BACKGROUND OF THE INVENTION

1. Field of the Invention

The present invention relates to a system, an apparatus, and a program for processing character information. The invention can be applied to a function of registering an external character, a file, and the like in a tape printing apparatus or a stamp (seal) producing apparatus.

2. Description of the Related Art

While the tape printing apparatus prints a string of inputted characters (it is assumed that the character string is a concept including a symbol, a pictograph, an outer frame, and a background pattern) in a continuous tape if necessary, the tape printing apparatus discharges and cuts the printed tape. The post-cutting tape in which the character string is printed is referred to as label.

The label is used in various applications. When compared with other prints, print contents in the label often contain a special character and a special symbol such as the pictograph and a logo, so that external character registration is performed to the tape printing apparatus and the registered external character is often used.

However, the tape printing apparatus has a small display surface and all the external characters used for the production are not displays at the same time, or the display of external characters used for the production becomes very small and usability is not good in the external character producing operation.

In Japanese Patent Application Laid-Open No. 7-137367, it is described that external character information produced by application software having an external character producing function is transmitted to an image processing apparatus and the image processing apparatus converts the external character information into a font format (font data) to store the external character information. It is thought that the method described in Japanese Patent Application Laid-Open No. 7-137367 can be applied to the tape printing apparatus.

However, even if the external character registering method described in Japanese Patent Application Laid-Open No. 7-137367 is applied to the tape printing apparatus, there are the following problems.

It is necessary that the tape printing apparatus has a function (process routine) of converting the external character information into the font data. Since a type of the necessary font data depends on the type of the tape printing apparatus, it is necessary that the process routine of converting the external character information into the font data is prepared in each type of the tape printing apparatus.

Japanese Patent Application Laid-Open No. 7-137367 also describes that, after the external character information is converted into the font data by the application software, the font data is transmitted to and stored in the image processing apparatus (tape printing apparatus). However, since there are many types of the tape printing apparatus in the market, depending on the type of the tape printing apparatus, the tape printing apparatus is lacking in the font data when using only the font data of converted size.

Although an upper limit number of external characters which can be registered as the external character depends on the type of the tape printing apparatus, the method described in Japanese Patent Application Laid-Open No. 7-137367 can not appropriately respond to difference in the upper limit number.

Even if there is the external character which is produced and registered in a certain tape printing apparatus, when the external character is registered in another tape printing apparatus, it is necessary that the external character is newly produced by the apparatus in which the application software of Japanese Patent Application Laid-Open No. 7-137367 is incorporated.

In addition to the external character registration function, the tape printing apparatus also has a file registration function, an address registration function, and the like. The problems, which are similar to the problems concerning the external character registration and are based on the difference in the type of tape printing apparatus, are also generated for the file registration function, the address registration function, and the like.

### SUMMARY OF THE INVENTION

In view of the foregoing, it is an object of the invention to provide a system, an apparatus, and a program for processing character information, which have high versatility and are applicable to various types of small print producing apparatus registration functions.

A character information processing system of the invention in which a small print producing apparatus and a character information processing apparatus are connected while data can be transmitted and received, the character information processing apparatus (1) includes registration data capturing means (1-1) for capturing one or a plurality of predetermined types of registration data from the small print producing apparatus, registration data supplying means (1-2) for supplying the plurality of predetermined types of registration data to the small print producing apparatus to register the plurality of predetermined types of registration data, and first registration data producing means (1-3) for newly producing the plurality of predetermined types of registration data or correcting the plurality of predetermined types of registration data, and the small print producing apparatus (2) includes second registration data producing means (2-1) for newly producing the plurality of predetermined types of registration data or correcting the plurality of predetermined types of registration data, registration data providing means (2-2) for replying the plurality of predetermined types of registration data stored in the small print producing apparatus in accordance with a request from the registration data capturing means, and reception data registering means (2-3) for registering the plurality of predetermined types of registration data supplied by the registration data supplying means in the small print producing apparatus.

A character information processing apparatus of the invention which is connected to a small print producing apparatus while data can be transmitted and received, the character information processing apparatus includes registration data capturing means for capturing one or a plurality of predetermined types of registration data from the small print producing apparatus, registration data supplying means for supplying the plurality of predetermined types of registration data to the small print producing apparatus to register the plurality of predetermined types of registration data, and registration data producing means for newly producing the plurality of predetermined types of registration data or correcting the plurality of predetermined types of registration data.

A character information processing program of the invention which is loaded in a computer connected to a small print producing apparatus while data can be transmitted and received, the character information processing program includes a registration data capturing function unit which captures one or a plurality of predetermined types of registration data from the small print producing apparatus, a registration data supplying function unit which supplies the plurality of predetermined types of registration data to the small print producing apparatus to register the plurality of predetermined types of registration data, and a registration data producing function unit which newly produces the plurality of predetermined types of registration data or correcting the plurality of predetermined types of registration data.

### BRIEF DESCRIPTION OF THE DRAWINGS

FIG. 1 is a block diagram showing a system configuration of a character information processing system of an embodiment;

FIG. 2 is a block diagram showing an electrical configuration of a tape printing apparatus of the embodiment;

FIG. 3 is a block diagram showing the electrical configuration of a character information processing apparatus of the embodiment;

FIG. 4 is an explanatory view showing a configuration of a character information processing program of the embodiment;

FIG. 5 is an explanatory view showing an initial registration screen of the embodiment;

FIG. 6 is a flowchart showing a process when the initial registration screen of the embodiment is displayed;

FIG. 7 is a flowchart showing the process when an external character is selected as a type of registration of the embodiment;

FIG. 8 is an explanatory view showing the registration screen when the process of FIG. 7 is ended;

FIG. 9 is an explanatory view showing the configuration of an external character model data table of the embodiment;

FIG. 10 is a flow chart showing a process for copying a registered character to the character information processing apparatus from the tape printing apparatus of the embodiment;

FIG. 11 is a flow chart showing the process for copying the registered character to the tape printing apparatus from the character information processing apparatus of the embodiment;

FIG. 12 is a flow chart showing a process for printing a registration external character font of the embodiment to general paper;

FIG. 13 is a flow chart showing a process for printing the registration external character font of the embodiment to a tape;

FIG. 14 is a flow chart showing a process for producing the external character of the embodiment;

FIG. 15 is an explanatory view showing an external character input screen of the embodiment; and

FIG. 16 is an explanatory view showing an external character read input screen of the embodiment.

### DETAILED DESCRIPTION OF THE PREFERRED EMBODIMENTS

### (A) Embodiment

Referring to accompanying drawings, a preferred embodiment of the system, apparatus, and program for processing character information will be described in detail. The character information processing system of the embodiment is intended to be used for label production.

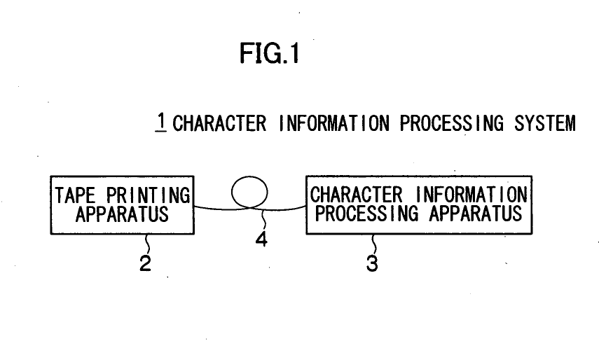

FIG. 1 is a block diagram showing an overall configuration of the character information processing system of the embodiment.

A character information processing system 1 of the embodiment includes a tape printing apparatus 2 and a character information processing apparatus 3 connected to the tape printing apparatus 2 through a cable 4. A stand-alone type personal computer or a notebook personal computer is appropriate to the character information processing apparatus 3. It is also possible that the tape printing apparatus 2 is connected the character information processing apparatus 3 through a wireless line.

The tape printing apparatus 2 can independently capture the character string printed in the label to print the character string in the tape, and the tape printing apparatus 2 can also receive supply of the print image of the character string captured with the character information processing apparatus 3 to print the character string in the internal tape. In different words, the tape printing apparatus 2 can act as a peripheral of the character information processing apparatus 3.

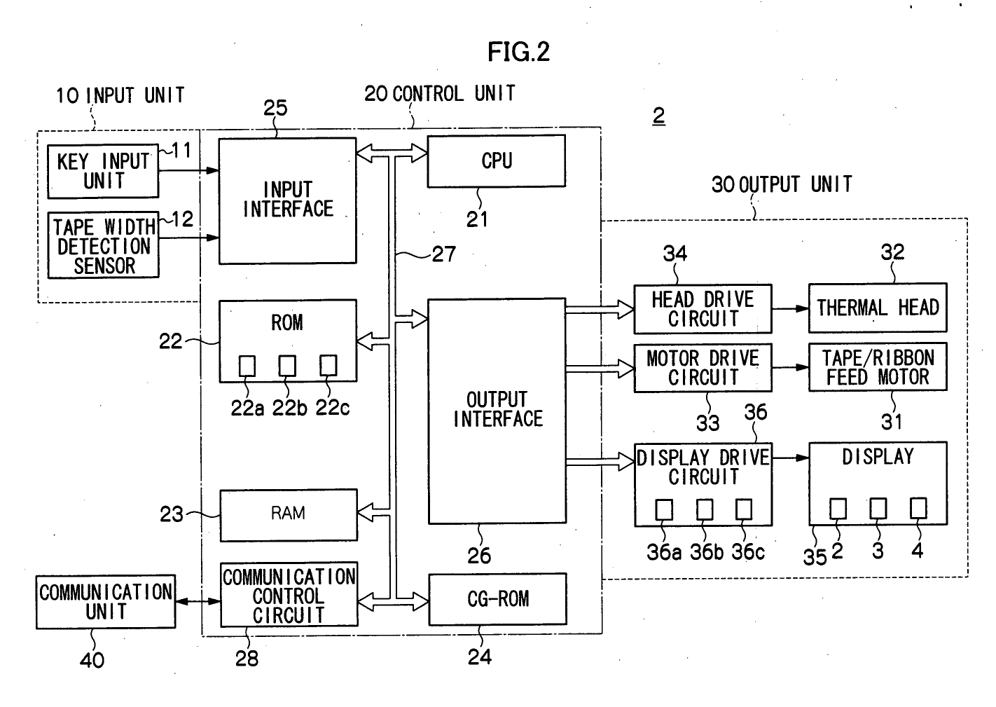

Referring to a functional block diagram of FIG. 2, the electrical overall configuration of the tape printing apparatus 2 will be described. In FIG. 2, the tape printing apparatus 2 mainly includes an input unit 10, a control unit 20, an output unit 30, and a communication unit 40. The control unit 20 is adapted to perform the process according to information from the input unit 10 or the communication unit 40 or a processing stage at that time to cause the output unit 30 to print or display the process result or to cause the communication unit 40 to transmit the process result to the character information processing apparatus 3.

Although the detail configuration of the input unit 10 will be omitted, the input unit 10 includes a key input unit 11 having a push down button (or a dial key) and a tape width detection sensor 12. The key input unit 11 generates the character code or various pieces of control data which are provided to the control unit 20. The tape width detection sensor 12 detects the width of the loaded tape to provide tape width information to the control unit 20. Actually the tape is stored in a tape cartridge, a physical identification element such as a hole defining the tape width is provided in the tape cartridge, and the tape width detection sensor 12 reads the physical identification element to output the tape width information.

The output unit 30 includes a printing configuration and a display configuration. A tape/ribbon feed motor 31 including a stepping motor or a DC motor feeds the loaded tape or ink ribbon (not shown) to a predetermined printing position or the outside of the apparatus. A print head (thermal head in the embodiment) 32 is fixed to perform the printing to the running tape by thermal transfer. The tape/ribbon feed motor 31 and the print head 32 are driven by a motor drive circuit 33 and a head drive circuit 34 under the control of the control unit 20 respectively. The printed tape is cut by external force from a user or a cutter (not shown) driven by a motor.

A liquid crystal display 35 is provided as a display unit of the tape printing system 2, and the liquid crystal display 35 is driven by a display drive circuit 36 under the control of the control circuit 20. The liquid crystal display 35 can display the characters having a predetermined size in several lines (for example, one line) and several columns (for example, six characters). A display surface of the liquid crystal display 35 includes a character display area for indicating the input character string, a line number indicator for indicating an input state of each line of the input character string, and an attribute indicator for indicating various attributes concerning the input character string.

The control unit 20 includes CPU 21, ROM 22, RAM 23, a character generator ROM (CG-ROM) 24, an input interface 25, an output interface 26, a system bus 27, and a communication control unit 28. CPU 21, ROM 22, RAM 23, the character generator ROM (CG-ROM) 24, the input interface 25, the output interface 26, and the communication control unit 28 are connected to one another through the system bus 27.

ROM 22 includes one or at least two ROM chips. Various processing programs and the fixed data such as kana-kanji conversion dictionary data are stored in ROM 22. For example, a communication processing program 22a for executing a communication process with the character information processing apparatus 3, a cooperation data registration program 22b for executing a data registration function in cooperation with the character information processing apparatus 3, and an independent data registration program for data registration function 22c which is executed in the tape printing apparatus 2 are also stored in ROM 22. The registration function which is of an object of the data registration programs 22b and 22c includes an external character registration function, a file registration function, an address registration function, and a name registration function.

The external character registration function is the registration function of a user-produced character (so-called external character) which is not prepared in CG-ROM 24, the file registration function is the function of registering the information on the character string repeatedly used for the label production at an interval as a file, the address registration function is the function of registering the information on the address character string (for example, the form is determined by the address and the name) repeatedly used for the label production at an interval, and the name registration function is the function of registering the information on the name which is repeatedly used for the label production and repeatedly inserted into a part of the character string (or the whole of character string).

RAM 23 includes one or at least two RAM chips and used as a working memory. RAM 23 also stores the fixed data with respect to user input and the like. Although RAM 23 is shown as RAM 23 in FIG. 2, it is assumed that RAM 23 has a broad concept including other memory devices such as EEPROM. RAM 23 has a printing buffer which performs dot expansion and storage of the printed character string, a display buffer in which a display image for the input character string is stored, a text buffer in which the character data concerning the printing and input is stored, and a communication buffer which properly stores data used for the communication.

In RAM (including EEPROM) 23, there is a storage area for the external character registration data, the file registration data, the address registration data, and the name registration data.

Dot patterns of the characters and symbols, which are prepared for the tape printing apparatus, are stored in CG-ROM 24. When code data specifying the character or the symbol is given, CG-ROM 24 outputs the corresponding dot pattern. It is also possible that CG-ROM for display and CG-ROM for printing are independently provided. It is possible that a storage format of font information is either an outline font format or a bit map format.

The input interface 25 is an interface between the input unit 10 and the control unit 20, and the output interface 26 is the interface between the output unit 30 and the control unit 20.

A communication control circuit 28 controls the communication unit 40 to perform data communication with the character information processing apparatus 3.

CPU 21 executes the processing program which is stored in ROM 22 and determined according to an input signal from the input unit 10, a reception signal given from the communication unit 40 through the communication control circuit 28, or a processing stage at that time, while utilizing RAM 23 as the working area or properly using the fixed data stored in ROM 22 or RAM 23 if necessary. CPU 21 causes the liquid crystal display 35 to display the processing status or the process result, causes the thermal head 32 to print the process result in the tape (not shown), or causes the communication unit 40 to transmit the processing status or the process result to the character information processing apparatus 3.

The communication unit 40 is hardware which performs the data communication with a driver and a cable through the cable 4. The communication unit 40 includes a connector. The communication unit 40 performs communication process under the control of the communication control circuit 28.

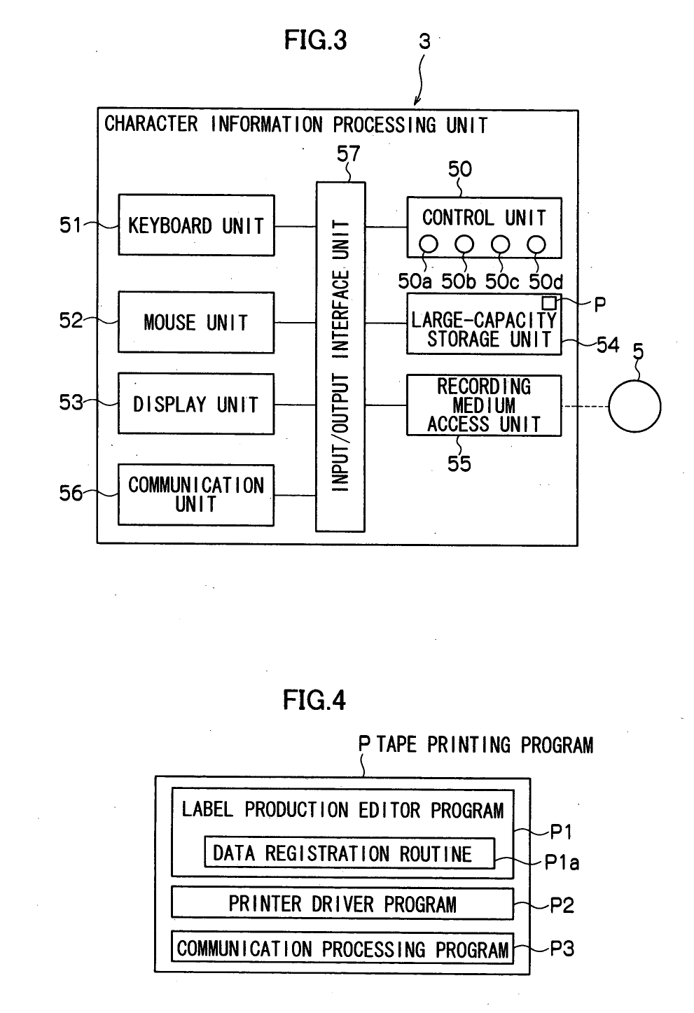

Then, the configuration of the character information processing apparatus 3 will be described referring to the block diagram of FIG. 3. In FIG. 3, the character information processing apparatus 3 includes a control unit 50, a keyboard unit 51, a mouse unit 52, a display unit 53, a large-capacity storage unit 54, a recording medium access unit 55, a communication unit 56 (including the communication control unit in the embodiment), and an input/output interface unit 57. The keyboard unit 51, the mouse unit 52, the display unit 53, the large-capacity storage unit 54, the recording medium access unit 55, and the communication unit 56 are connected to the control unit 50 through the input/output interface unit 57.

The control unit 50 in the character information processing apparatus 3 includes CPU 50a, ROM 50b, RAM 50c, and CG-ROM 50d. CPU 50a performs the processing according to the program stored in ROM 50b or RAM (including EEPROM) 50c while utilizing RAM 50c as the working memory. In the display output process and the print output process, CPU 50a properly sets the display buffer or the printing buffer in RAM 50a or the like to perform the process while properly utilizing the storage data of CG-ROM 50d.

The keyboard unit 51 is integrally provided in an apparatus chassis or the keyboard unit 51 is provided independently of the apparatus chassis. The keyboard unit 51 is used for the input of the input character or the control information. The mouse unit 52 is connected to the apparatus chassis through the cable. The mouse unit 52 is used for a cursor movement direction, an icon selection direction, and the like. It is also possible to apply other pointing device instead of the mouse unit 52, and it is also possible that other pointing device is integrally provided in the apparatus chassis.

A CRT display or a liquid crystal display is appropriate to the display unit 53. The display unit 53 displays the image under the control of the control unit 50.

A hard disk drive or the like is appropriate to the large-capacity storage unit 54. The large-capacity storage unit 54 stores the various programs, the data, and the installed application program. Depending on a load of the process, the large-capacity storage unit 54 also acts as the working memory for complementing RAM 50c in the control unit 50.

RAM 50c and/or the large-capacity storage unit 54 (or the recording medium loaded in the recording medium access unit 55) acts as the storage unit of the external character registration data, the file registration data, the address registration data, and the name registration data (registration data file).

In the embodiment, a tape printing program P is stored in the large-capacity storage unit 54.

An external or built-in access apparatus for the recording medium such as CD-ROM and a flexible disk is appropriate to the recording medium access unit 55. The recording medium for inputting and outputting various pieces of data or the recording medium which stores the application program and installs the application data in the apparatus is loaded in the recording medium access unit 55. The recording medium includes a recording medium 5 which stores the data printing program P. It is also possible to provide the plurality of recording medium access units 55 in each type of the recording medium.

The tape printing program P can be copied (installed) in the large-capacity storage unit 54 not only by reading the tape printing program P from and storing the tape printing program P in the recording medium 5 but also by downloading the tape printing program P from other apparatus.

The communication unit (including the communication control circuit) 56 includes a driver, a receiver, and hardware for controlling the driver and the receiver. The communication unit 56 performs the communication with the tape printing apparatus 2.

The input/output interface unit 57 has the function of the interface between the control unit 50 and other processing units. Each processing unit individually has the interface unit, though the interface unit is not clearly shown in FIG. 3.

Although an external (or built-in) printer unit is omitted in FIG. 3, it is possible that the external printer unit is provided in the character information processing apparatus 3.

As shown in FIG. 4, the tape printing program P which is stored in the recording medium 5 and copied (installed) in the large-capacity storage unit 54 mainly includes a label production editor program P1, a printer driver program P2, and a communication processing program P3.

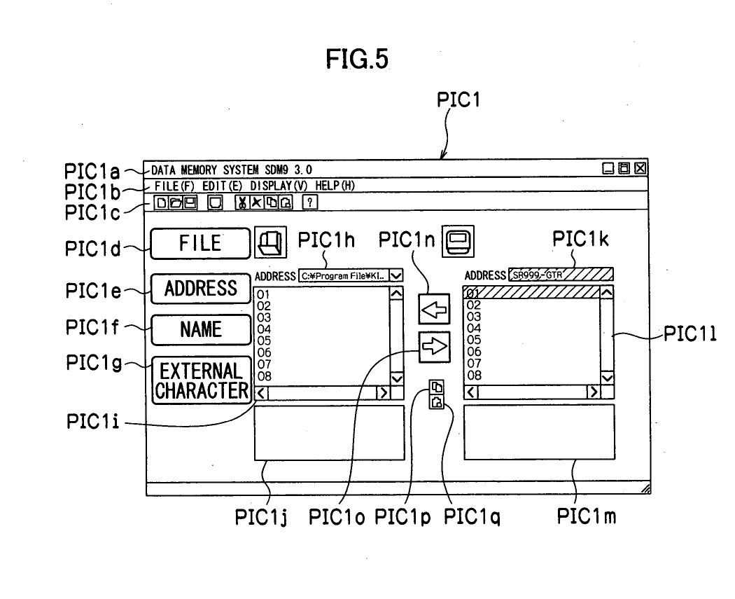

The label production editor program P1 assumes an edit function of inputting or correcting contents printed in the label or inputting and outputting the contents as the file. A data registration routine P1a (see FIG. 5) is provided as one of processing routines of the label production editor program P1. The printer driver program P2 is a program which performs a printing drive process to the tape printing apparatus 2. The printer driver program P2 performs the dot expansion of the print contents data to convert the data into the print image data. The communication processing program P3 is a software which performs the process for communicating with the tape printing apparatus 2. The communication processing program P3 is properly utilized by the label production editor program P1 or the printer driver program P2.

Then, an action (character information processing method) of the character information processing system 1 of the embodiment will be described. One of the features of the embodiment is the data registration function concerning the label production function. The action concerning the data registration function will be described below.

A user uses the keyboard unit 51 or the mouse unit 52 in the character information processing apparatus 3 to open the installed tape printing program P as the application program desired for the process. For example, immediately after the tape printing program P is opened, the label production editor program P1 becomes valid, the data registration routine P1a becomes valid by selecting “data registration” function from options in the initial menu screen or lower-hierarchy menu screen (not shown), and an initial registration image PIC concerning the data registration is displayed on the display unit 53 as shown in FIG. 5.

When the object of the data registration is the tape printing apparatus 2, or when the data already registered in the tape printing apparatus 2 is utilized, the user is required to connect previously the tape printing apparatus 2 and the character information processing apparatus with the cable 4.

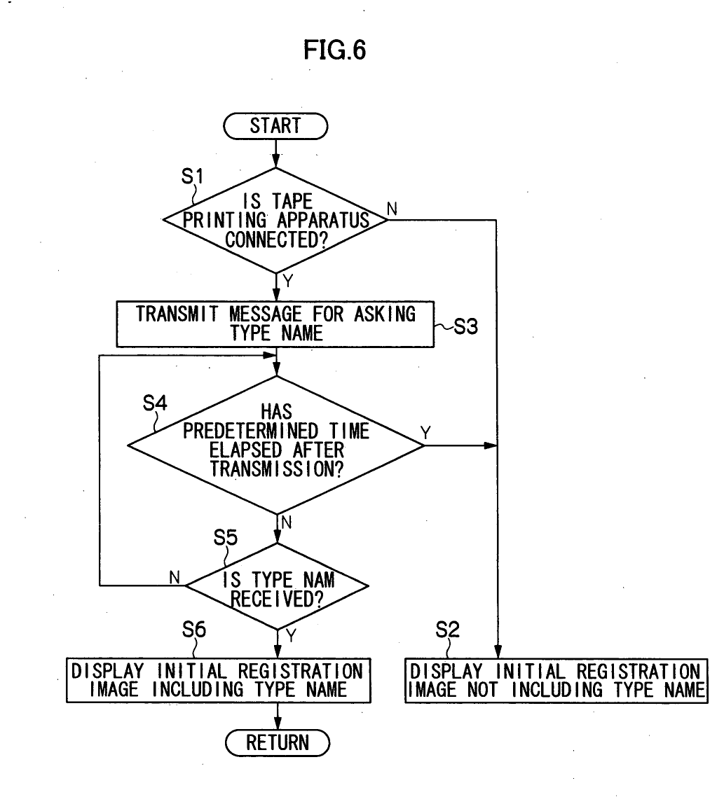

FIG. 6 is a flow chart showing the process (a part of data registration routine P1a) performed by CPU 50a when the option of “data registration screen” is selected. When the option of “data registration screen” is selected, CPU 50a starts the process shown in FIG. 6 and decides whether the cable 4 is connected to the communication unit 56 of the apparatus 3 or not (S1). When the cable 4 is disconnected to the communication unit 56, CPU 50a causes the display unit 56 to display the initial registration screen PIC1 not including the type name of the tape printing apparatus 2 (S2) and returns to the main routine.

When the cable 4 is connected, CPU 50a transmits a message for asking the type name to the tape printing apparatus 2 through the communication unit 56 (S3) and waits for a reply for a predetermined time (S4 and S5). When the reply is not received within the predetermined time (including the case where the type name is exempted from the apparatus 3 (data registration routine P1a) though the reply is received), CPU 50a causes the display unit 56 to display the initial registration screen PIC1 not including the type name of the tape printing apparatus 2 (S2) and returns to the main routine. When the valid reply is received, CPU 50a causes the display unit 56 to display the initial registration screen PIC1 including the type name of the tape printing apparatus 2 (S6) and returns to the main routine.

Although the description will be omitted in the flow chart of FIG. 6, CPU 21 in the tape printing apparatus 2 connected to the character information processing apparatus 3 with the cable 4 transmits the reply message including the type name of itself in accordance with the cooperation data registration program 22b, when CPU 21 receives the message for asking the type name. For the message for asking the type name to the tape printing apparatus 2, since communication specifications of the tape printing apparatus 2 is not clear, all the communication specifications with which the character information processing apparatus 3 is compatible are sequentially transmitted.

The initial registration image PIC1 includes a title bar PIC1a, a function menu bar PIC1b, and process icon bar PIC1c on the upper portion of the image.

The initial registration image PIC1 has a “File” icon PIC1d, an “Address” icon PIC1e, a “Name” icon PIC1f, and an “External character” icon PIC1g on the left side in the central portion. The icons PIC1d to PIC1g are displayed in the off state immediately after the initial registration image PIC1 is displayed. The “File” icon PIC1d is used for providing the direction of the file registration function, the “Address” icon PIC1e is used for providing the direction of the address registration function, the “Name” icon PIC1f is used for providing the direction of the name registration function, and the “External character” icon PIC1g is used for providing the direction of the external character registration function.

While an input display field PIC1h of the initial registration image PIC1 displays the file names indicating the files in the storage mediums and storage folders in the character information processing apparatus 3, the input display field PIC1h changes (addresses of) the storage mediums and storage folders according to the operation of a scroll operator icon located on the right end of the input display field PIC1h. The initial registration image PIC1 includes displays a blank when all the registration function selection icons PIC1d to PIC1g are in the off state.

A display area PIC1i located immediately below the input display field PIC1h is the area (hereinafter properly referred to as registration list display area) which displays a list of identification information (for example, reading in the external character) on the registration contents of the file in the storage mediums and storage folders written in the input display field PIC1h. When all the registration function selection icons PIC1d to PIC1g are in the off state, the display area PIC1i becomes blank. In this case, the serial number for distinguishing registration contents may be displayed.

A display area PIC1j located immediately below the registration list display area PIC1i is the area (hereinafter properly referred to as registration contents display area) which displays the registration contents of the identification information at which the cursor is located in the registration list display area PIC1i. When the cursor is not displayed in the registration list display area PIC1i, or when the cursor is displayed at a position where the identification information does not exist, the information is not displayed in the registration contents display area PIC1j.

A display field PIC1k of the initial registration image PIC1 displays the type name of the tape printing apparatus 2 connected to the character information processing apparatus 3. When the tape printing apparatus 2 is disconnected (including the case where the type of tape printing apparatus 2 not compatible with the character information processing apparatus 3 is connected), the display field PIC1k becomes blank. When the user moves the cursor to the display field PIC1k to click the mouse unit 52, CPU 50a performs the process substantially similar to the process of FIG. 6. Namely, when the tape printing apparatus 2 connected to the character information processing apparatus 3 is changed to other tape printing apparatus 2, or when the tape printing apparatus 2 is connected to the character information processing apparatus 3, the user moves the cursor to the display field PIC1k to click the mouse unit 52, which allows (CPU 50a of) the character information processing apparatus 3 to capture newly the type name of the tape printing apparatus 2.

Either the input display field PIC1h concerning the storage mediums and storage folders in the character information processing apparatus 3 or the input display field PIC1k concerning the type name of the connected tape printing apparatus 2 becomes selectively valid (for example, the valid side is inversely displayed).

Display areas PIC1l and PIC1m are the registration list display area and the registration contents display area for the tape printing apparatus 2 connected to the character information processing apparatus 3 respectively. The maximum value of the serial number in the registration list display area PIC1l is equal to the upper limit of the number of registrations permitted in the connected tape printing apparatus 2.

A pick up copy icon PIC1n provides the direction to copy the registration information of the connected tape printing apparatus 2 to the storage medium and storage folder, which are defined by the input display field PIC1h, in the character information processing apparatus 3. The process in the operation of the pickup copy icon PIC1n will be described later.

A supply copy icon PIC1o provides the direction to copy the registration information of the connected tape printing apparatus 2 to the storage medium and storage folder, which are defined by the input display field PIC1h, in the character information processing apparatus 3. The process in the operation of the supply copy icon PIC1o will be described later.

A paper printing icon PIC1p provides the direction to cause the printer unit included in the character information processing apparatus 3 to print the registration contents displayed on the registration contents display area PIC1j or PIC1m which becomes valid. A tape printing icon PIC1q provides the direction to cause the connected tape printing apparatus 2 to print the registration contents displayed on the registration contents display area PIC1j or PIC1m which becomes valid. Operating the icons PIC1p and PIC1m, the user can confirm the registration contents with the registration contents printed. The process in the operation of the icons PIC1p and PIC1m will be described later.

Since the subsequent actions are substantially similar by operating any one of the icons PIC1d to PIC1g, the case in which the “External character” icon PIC1g is operated will be described below.

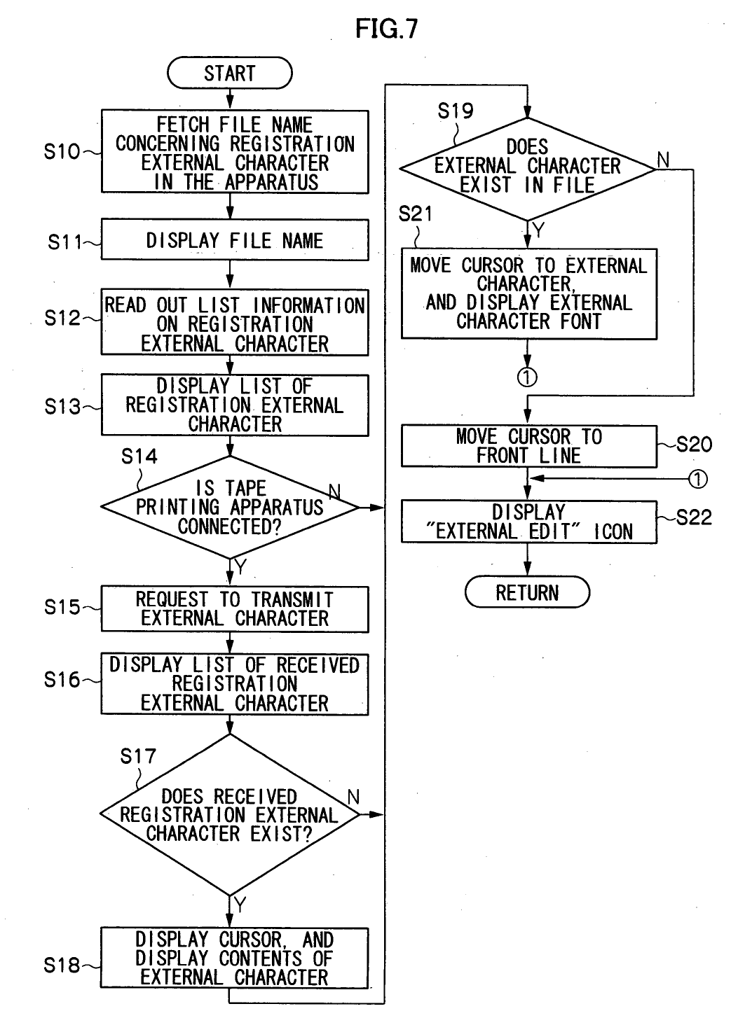

FIG. 7 is the flow chart showing the process performed by the character information processing apparatus 3 when the “External character” icon PIC1g is operated. When the user desires some sort of process concerning the external character registration function, the user operates the “External character” icon PIC1g.

When the “External character” icon PIC1g is operated, CPU 50a of the character information processing apparatus 3 starts the process shown in FIG. 7. While CPU 50a fetches a default in which the external character is registered or the file name concerning the immediately preceding process in the character information processing apparatus 3 (S10), CPU 50a displays the default or the file name in the input display field PIC1h (S11) and reads out the external character list information stored in the file (S12) to display the external character list information in the registration list display area PIC1i (S13).

Then, CPU 50a decides whether the tape printing apparatus 2 compatible with the character information processing apparatus 3 is connected to the character information processing apparatus 3 or not (S14).

When the tape printing apparatus 2 is connected, CPU 50a requests the tape printing apparatus 2 to transmit the stored external character information (S15). While CPU 50a buffers the received external character information inside, CPU 50a displays the list of the readings of the external characters stored in the tape printing apparatus 2 (in the case of the external character, the reading is set to the identification information) in the display field PIC1l (S16). When the registration external character does not exist, the display field PIC1l is held at the blank state.

Although the description will be omitted in the flow chart of FIG. 7, CPU 21 in the tape printing apparatus 2 connected to the character information processing apparatus 3 with the cable 4 replies the registration external character information (including the absence of the external character information) in accordance with the cooperation data registration program 22b, when CPU 21 receives the request for transmitting the registration external character information.

Then, CPU 50a decides whether the connected tape printing apparatus 2 has the registration external character or not (S17).

When the tape printing apparatus 2 has the registration external character, CPU 50a displays the contents of the external character (external character font) concerning the identification information in the registration contents display area PIC1m, while CPU 50a moves the cursor to the line of the identification information having the smallest number, in which the external character is registered in the display field PIC1l (S18). In the display, for example, the largest font is displayed in the connected tape printing apparatus 2. For example, when the connected tape printing apparatus 2 contains the six types of font of 16 by 16, 24 by 24, 30 by 30, 32 by 32, 40 by 40, and 48 by 48 matrixes of pixels, CPU 50a displays the font of the 48 by 48 matrix of pixels. When the connected tape printing apparatus 2 contains the four types of font of 16 by 16, 24 by 24, 32 by 32, and 48 by 48 matrixes of pixels, CPU 50a displays the font of 48 by 48 matrix of pixels (see FIG. 9).

When the tape printing apparatus 2 does not have the registration external character, or when the tape printing apparatus 2 is disconnected, CPU 50a decides whether the registration external character exists in the file displayed in the file name in the input display field PIC1h or not (S19). When the registration external character does not exist, CPU 50a moves the cursor to the line of the identification information of “01” in the display field PIC1l (S20). When the registration external character exists, CPU 50a display the contents of the external character (external character font) concerning the identification information in the registration contents display area PIC1j, while CPU 50a moves the cursor to the line of the identification information having the smallest number, in which the external character is registered in the display field PIC1i (S21). The method of moving the cursor to the display field PIC1i or PIC1l is not limited to the embodiment.

Then, CPU 50a additionally displays an “External character edit” icon PIC1r (S22) and returns to the main routine. It is also possible to additionally display the pick up copy icon PIC1n, the supply copy icon PIC1o, the paper printing icon PIC1p, and/or the tape printing icon PIC1q from Step S22.

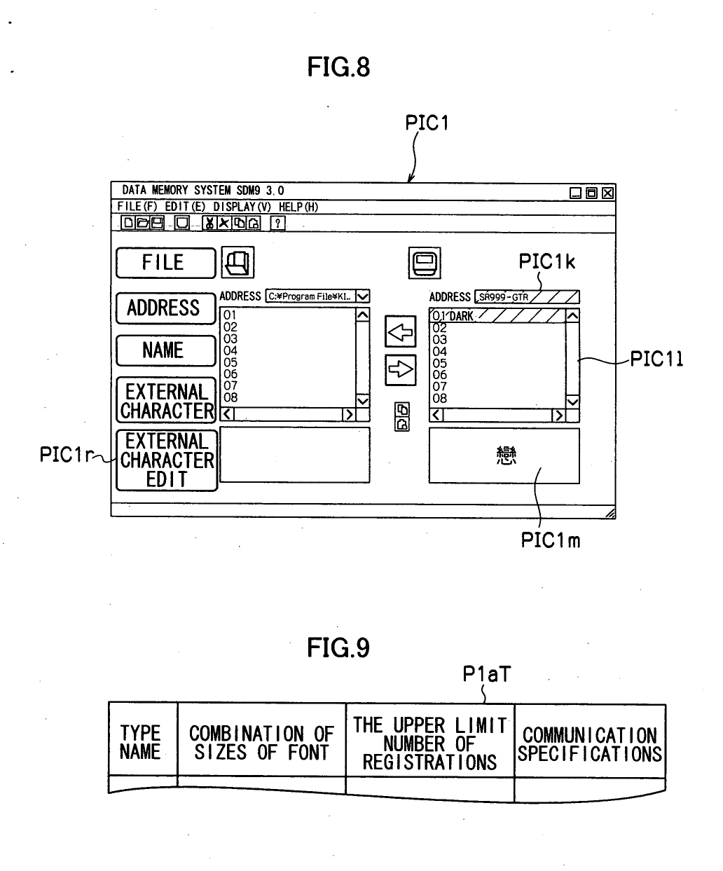

FIG. 8 shows an example of the display contents of the registration image PIC1 after a series of processes of FIG. 7 are finished. In the example of FIG. 8, the tape printing apparatus 2 is connected, the external character “ [symbol] ” having the reading of “koi” is registered, and the external character is not registered in the file which currently specified in the character information processing apparatus 3.

FIG. 9 is the explanatory view showing an example of the configuration of an external character model data table P1aT constituting a part of the data registration routine P1a. The external character model data table P1aT specifies the type name of the tape printing apparatus 2 to which the external character registration process can be performed by the character information processing apparatus 3, the information on combination of font sizes in the type, the upper limit number of external characters which can be registered, the communication specifications with the type of tape printing apparatus 2 (a communication rate, a communication method, and the like), and the like. It is possible that the data table is independently formed by the external character, or it is possible that the data table is formed while mixed with other registration types such as the address.

The information on the external character model data table P1aT is properly utilized in the above-described process concerning the external character registration or the process described later.

It is preferable that the data registration routine P1a includes the process routine which can edit the external character model data table P1aT. It is preferable that the data registration routine P1a includes the process routine which automatically performs the addition process through the initial negotiation communication with the new tape printing apparatus 2.

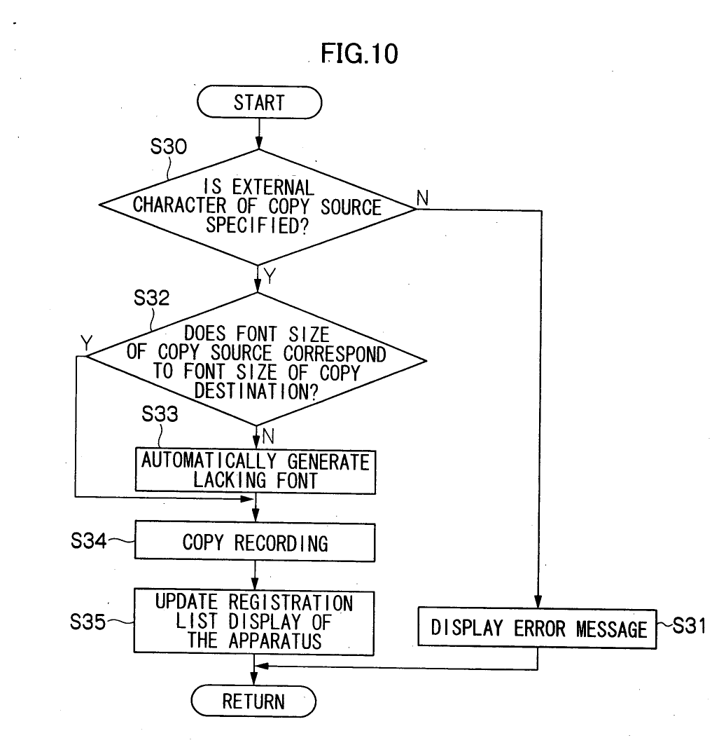

FIG. 10 is the flow chart showing the process when the pick up copy icon PIC1n is operated. When the user desires to copy the registration external character of the connected tape printing apparatus 2 to (the predetermined file of) the character information processing apparatus 3, the user operates the pick up copy icon PIC1n. In the case of FIG. 10, in the character information processing apparatus 3, while the process is performed on the basis of contents of a registration external character information buffer of the tape printing apparatus 2, it is possible to perform the process of fetching the font of the specific external character from the tape printing apparatus 2 in each case.

When the pick up copy icon PIC1n is operated, CPU 50a of the character information processing apparatus 3 starts the process shown in FIG. 10. CPU 50a decides whether the cursor is displayed or not in the position where the identification information in the registration list display area PIC1l concerning the tape printing apparatus 2 exists (i.e. whether the registration external character of the copy source is specified or not) (S30).

When the cursor is displayed at the position where the identification information does not exist, CPU 50a displays an error message for demanding the specification of the copy source for the predetermined time (S31) and returns to the main routine.

When the cursor is displayed at the position where the identification information exists, CPU 50a decides whether the combination of the font sizes in the type of the connected tape printing apparatus 2 satisfy the combination of the font sizes required in the character information processing apparatus 3 or not (S32). For example, the combination of the font sizes required in the character information processing apparatus 3 is the combination of all the font sizes. Even if there is the font size which is adopted by only one type of the character information processing apparatus 3, the character information processing apparatus 3 sets the font size as the required element. When the combination of the font sizes required by the character information processing apparatus 3 are the six types of font of 16 by 16, 24 by 24, 30 by 30, 32 by 32, 40 by 40, and 48 by 48 matrixes of pixels and the combination of the font sizes in the currently connected tape printing apparatus 2 are the four types of font of 16 by 16, 24 by 24, 32 by 32, and 48 by 48 matrixes of pixels, the condition is not satisfied in the decision of Step S32.

When the combination of the font sizes in the type of the connected tape printing apparatus 2 satisfy the combination of the font sizes required in the character information processing apparatus 3, CUP 50a stores the combination of the font sizes in the area corresponding to the smallest number in the blank in the file of copy destination (it is also possible that the user select the serial number of the storage area) (S34). When the combination of the font sizes in the type of the connected tape printing apparatus 2 does not satisfy the combination of the font sizes required in the character information processing apparatus 3, CPU 50a automatically generates the pattern of the font size lacking in the connected tape printing apparatus 2 (30 by 30 and 40 by 40 matrixes of pixels in the above example) and stores the combination of the font sizes including the automatically generated font size in the area corresponding to the smallest number in the blank in the file of copy destination (it is also possible that the user select the serial number of the storage area) (S33 and S34). It is also possible to correct dot pattern data of the automatically generated font size.

Then, CPU 50a updates the display of the registration list display area PIC1i concerning the character information processing apparatus 3 so that display includes the copied item (S35) and returns to the main routine.

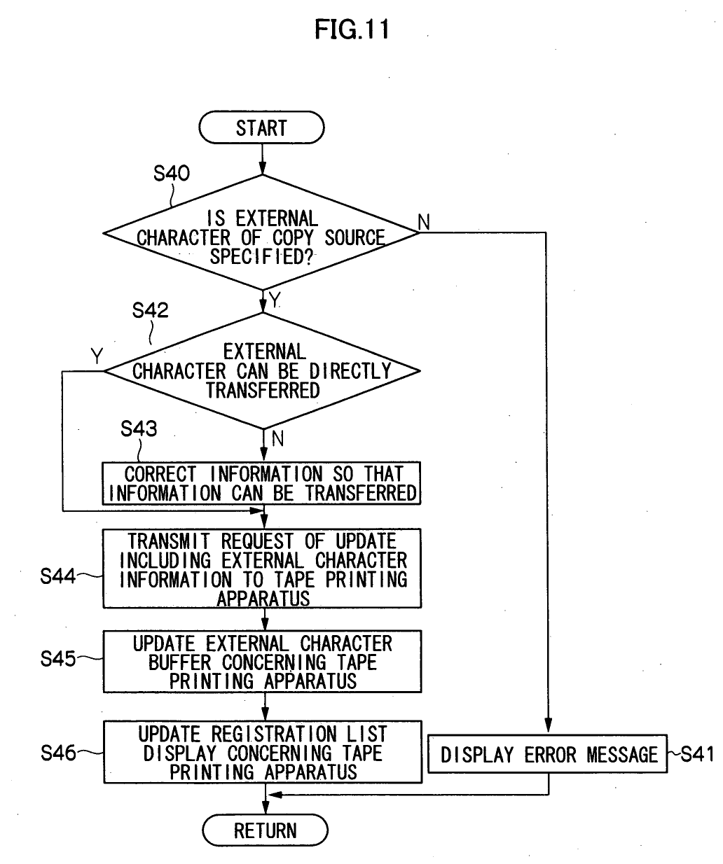

FIG. 11 is the flow chart showing the process when the supply copy icon PIC1o is operated. When the user desires to copy the registration external character of (the predetermined file of) the character information processing apparatus 3 to the tape printing apparatus 2, the user operates the supply copy icon PIC1o.

When the supply copy icon PIC1o is operated, CPU 50a of the character information processing apparatus 3 starts the process shown in FIG. 11. CPU 50a decides whether the cursor is displayed or not in the position where the identification information in the registration list display area PIC1i concerning the character information processing apparatus 3 exists (i.e. whether the registration external character of the copy source is specified or not) (S40).

When the cursor is displayed at the position where the identification information of the registration list display area PIC1i does not exist, CPU 50a displays an error message demanding the specification of the copy source for the predetermined time (S41) and returns to the main routine.

When the cursor is displayed at the position where the identification information of the registration list display area PIC1i exists, CPU 50a decides whether the type of the tape printing apparatus 2 to which the combination of the font sizes registered in the character information processing apparatus 3 can be directly transferred is connected to the character information processing apparatus 3 or not (S42). For example, when the combination of the font sizes registered in the character information processing apparatus 3 are the six types of font of 16 by 16, 24 by 24, 30 by 30, 32 by 32, 40 by 40, and 48 by 48 matrixes of pixels and the combination of the font sizes in the currently connected tape printing apparatus 2 are the four types of font of 16 by 16, 24 by 24, 32 by 32, and 48 by 48 matrixes of pixels, the result that the combination of the font sizes registered in the character information processing apparatus 3 can not be directly transferred is obtained in the decision of Step S42.

When the registration external character information in the character information processing apparatus 3 can not be directly transferred, CPU 50a corrects the registration external character information to the information which can be transferred (S43). For example, in the above-described case, CPU 50a extracts four types of the font from the six types to correct the registration external character information to the information which can be transferred. In this case, CPU 50a retains the registration external character information of the file in the character information processing apparatus 3 without change.

When the registration external character information in the character information processing apparatus 3 can be directly transferred, or when the registration external character information is corrected to the information which can be transferred, CPU 50a of the character information processing apparatus 3 transmits the update request for including the copied external character information to the connected tape printing apparatus 2 (S44). When CPU 50a receives the reply indicating the end of the update from the connected tape printing apparatus 2, CPU 50a updates the contents of the registration external character information buffer for the tape printing apparatus 2 in the character information processing apparatus 3 (S45) and updates the display of the registration list display area PIC1l concerning the tape printing apparatus 2 so that the display includes the copied external character (S46) and returns to the main routine.

When the external character information is transmitted to the tape printing apparatus 2, CPU 50a determines the serial number concerning the copied external character. For example, the copied external character is set to the smallest serial number in the blank. When the serial numbers are filled (the maximum value of the serial number depends on the type), CPU 50a displays the error message to return to the main routine, however, the description is omitted in FIG. 11. In transmitting the external character information to the tape printing apparatus 2, it is possible to transmit only the copied external character information (serial number, reading, and font of each size), it is possible to transmit all the pieces of external character information including the copied external character information concerning the tape printing apparatus 2.

Although the description is omitted in the flow chart of FIG. 11, CPU 21 of the tape printing apparatus 2 connected to the character information processing apparatus 3 with the cable 4 updates the registered external character information (including the absence of the external character information) in accordance with the cooperation data registration program 22b and replies the end of the update, when CPU 21 receives the update request of the registered external character information.

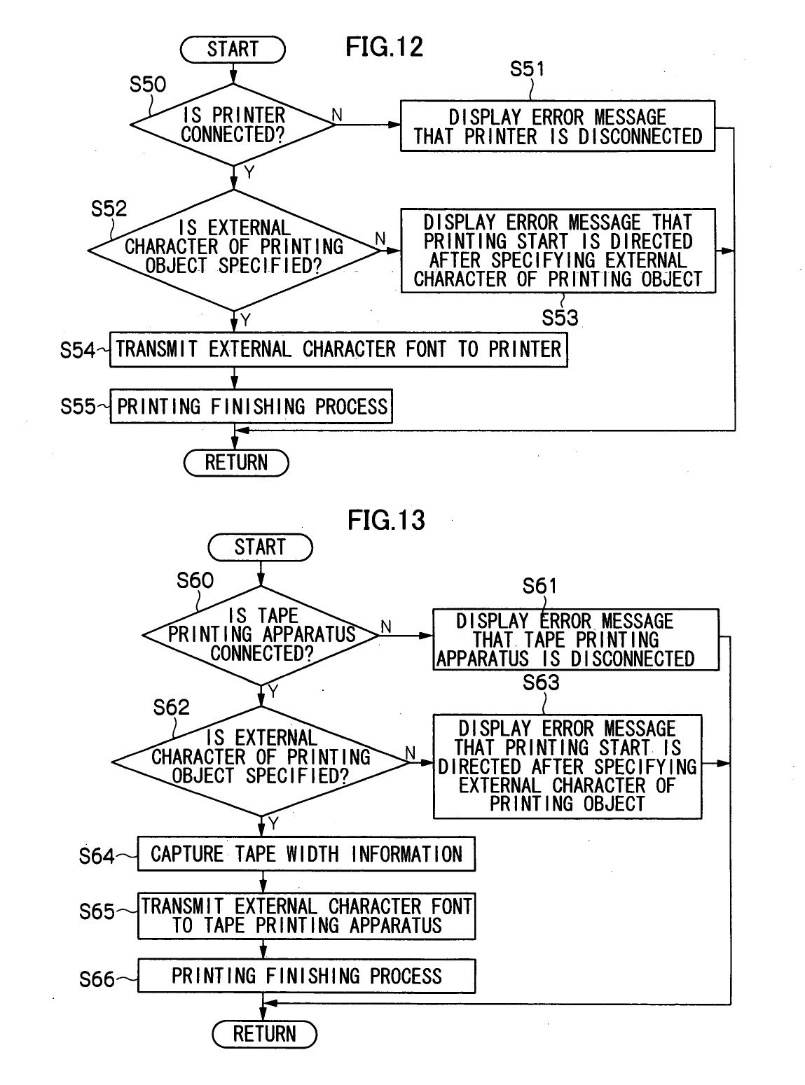

FIG. 12 is the flow chart showing the process when the paper printing icon PIC1p is operated. When the user desires to confirm the contents (print image and the like) of the registration external character by printing the contents of the registration external character with the printer (not shown in FIG. 3) connected to the character information processing apparatus 3, the user operates the paper printing icon PIC1p.

When the paper printing icon PIC1p is operated, CPU 50a of the character information processing apparatus 3 starts the process shown in FIG. 12. CPU 50a decides whether the printer whose power is turned on is connected to the character information processing apparatus 3 or not (S50). When the printer whose power is turned on is disconnected, CPU 50a display the message that the printing can not be performed (S51) and returns to the main routine. At this point, it is also possible that CPU 50a waits the execution of printing preparation on the printer side.

When the printer whose power is turned on is connected, CPU 50a decides whether the cursor is displayed at the position where the identification exists in the registration list display area PIC1i or PIC1l (i.e. the registration external character to be printed is specified or not) (S52).

When the cursor is displayed at the position where the identification information does not exist, CPU 50a displays the error message that the printing start is directed after specifying the registration external character to be printed (S53) and returns to the main routine. In displaying the error message, it is also possible to specify the registration external character to be printed.

When the cursor is displayed at the position where the identification information exists, CPU 50a forms the print image by performing the dot expansion of the registration external character into a printing buffer having the font of the registration external character which is of the printing object on the basis of a stored printing attribute for the case in which the printing medium is the printing paper. While CPU 50a transmits the print image to the printer, CPU 50a displays the message of “in printing” (S54). Then, CPU 50a receives the reply of the end of the printing (S55) and returns to the main routine.

In the printing process, the function of the printer driver program P2 (dot expansion function and the like) is properly utilized.

The print image printed by the printer includes the images of all the font sizes (all the font sizes permitted by the tape printing apparatus 2 in the case of the registration external character in the tape printing apparatus 2), and the image of each font includes the information on the size such as “24 by 24.” It is possible that the image of the font is printed in each several-fold size in the lengthwise and crosswise directions relative to the size actually printed by the tape printing apparatus 2. It is possible that to print only the font of the typical size (for example, 32 by 32) instead of the printing of the fonts of all the sizes. It is possible that the print image includes frame line such that the frame line is suggestive of a label and the registration external character is printed within the frame line.

FIG. 13 is the flow chart showing the process when the tape printing icon PIC1q is operated. When the user desires to confirm the contents of the registration external character by printing the contents of the registration external character with the tape printing apparatus 2 connected to the character information processing apparatus 3, the user operates the tape printing icon PIC1q.

When the tape printing icon PIC1q is operated, CPU 50a of the character information processing apparatus 3 starts the process shown in FIG. 13. CPU 50a decides whether the tape printing apparatus 2 (it is necessary that the power is turned on) is connected to the character information processing apparatus 3 or not (S60). When the tape printing apparatus 2 is disconnected, CPU 50a display the message that the printing can not be performed (S61) and returns to the main routine. At this point, it is also possible that CPU 50a waits the execution (connection) of the printing preparation on the side of the tape printing apparatus 2.

When the tape printing apparatus 2 is connected, CPU 50a decides whether or not the cursor is displayed at the position where the identification exists in the registration list display area PIC1i or PIC1l (i.e. the registration external character to be printed is specified or not) (S62).

When the cursor is displayed at the position where the identification information does not exist, CPU 50a displays the error message that the printing is started after specifying the registration external character to be printed (S63) and returns to the main routine. In displaying the error message, it is also possible to specify the registration external character to be printed.

When the cursor is displayed at the position where the identification information exists, CPU 50a transmits the request to transmit tape width information to the connected tape printing apparatus 2 and captures the tape width information replied from the tape printing apparatus 2 (S64). Although the description is omitted in the flow chart of FIG. 13, when the tape (tape cassette) is not loaded in the tape printing apparatus 2, the tape printing apparatus 2 reply the message that the tape is not loaded to CPU 50a, and CPU 50a display the error message that the tape is not loaded and returns to the main routine. At this point, it is also possible that CPU 50a directs the tape printing apparatus 2 to load the tape. It is possible that CPU 50a directs the tape printing apparatus 2 to load the tape having the predetermined width immediately after the tape printing icon PIC1q is operated.

CPU 50a forms the print image by performing the dot expansion of the registration external character into the printing buffer having the font of the registration external character which is of the printing object on the basis of the stored printing attribute according to the tape width. While CPU 50a performs the printing by transmitting the print image to the tape printing apparatus 2, CPU 50a displays the message of “in printing” (S65). Then, CPU 50a receives the reply of the end of the printing from the tape printing apparatus 2 (S66) and returns to the main routine.

In the tape printing process, the function of the printer driver program P2 (dot expansion function and the like) is also properly utilized.

The print image printed by the tape printing apparatus 2 also includes the images of all the font sizes (all the font sizes permitted by the connected tape printing apparatus 2 in the case of the registration external character in the connected tape printing apparatus 2), and the image of each font includes the information on the size such as “24 by 24.” It is possible that to print only the font of the typical size (for example, 32 by 32) instead of the printing of the fonts of all the sizes.

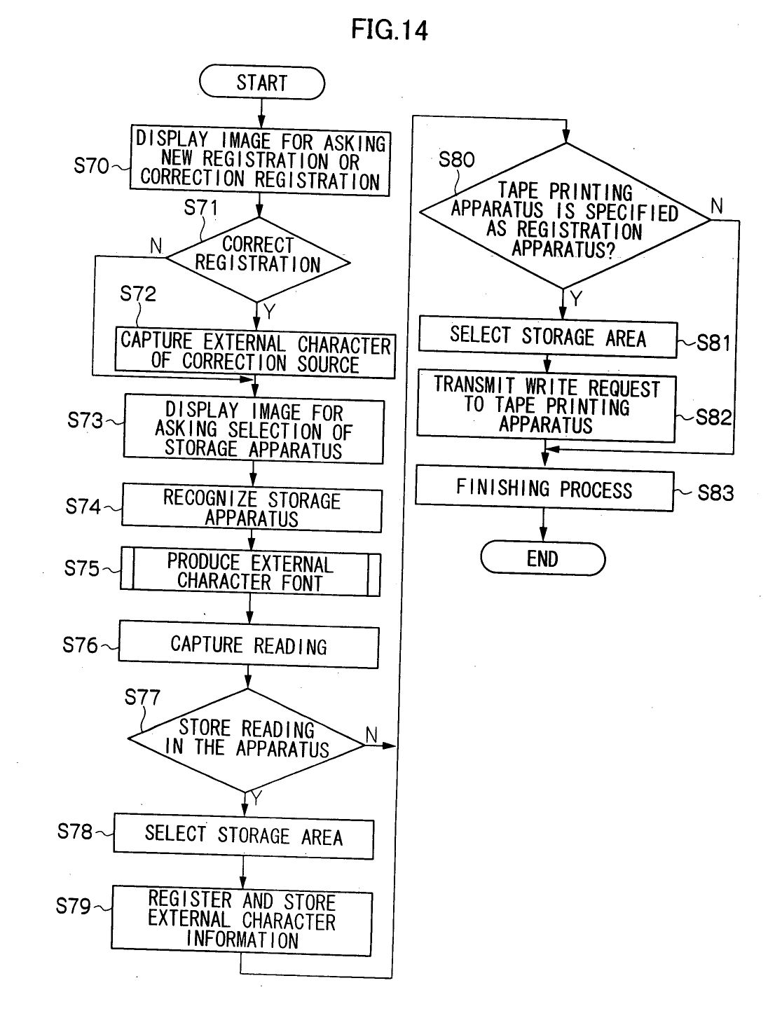

FIG. 14 is the flow chart showing the process when the “External character edit” icon PIC1r is operated. When the user desires to register the external character by newly producing the external character or to register the external character by correcting the registration external character, the user operates the “External character edit” icon PIC1r.

Then, CPU 50a starts the process shown in FIG. 14. CPU 50a displays the image (not shown) including a new registration icon and a correction registration icon (S70). CPU 50a captures the user's operation information according to the new registration icon and the correction registration icon to decide whether the new registration icon or the correction registration is specified (S71). When the correction registration is specified, the registration external character to be corrected is selected (S72). After that, when the new registration is specified, CPU 50a immediately displays the image (not shown) for selecting the apparatus containing the produced external character or the corrected external character (S73). Then, CPU 50a captures the user's operation information according to the new registration or the correction registration to recognize the apparatus containing the external character (S74) in the registration external character to be corrected, CPU 50a causes the user to perform the selection by displaying the image shown in FIG. 8 with the message that the user is required to click the selection external character. In the image shown in FIG. 8 at the time when the “External character edit” icon PIC1r is operated, when the registration external character does not exist in display areas PIC1i and PIC1l, it is possible that CPU 50a automatically decides that the new registration is specified.

The options of the apparatus containing the registration external character include (1) the connected tape printing apparatus 2, (2) the character information processing apparatus 3 (i.e. the file displayed in the input display field PIC1h in FIG. 8), and (3) both the connected tape printing apparatus 2 and the character information processing apparatus 3.

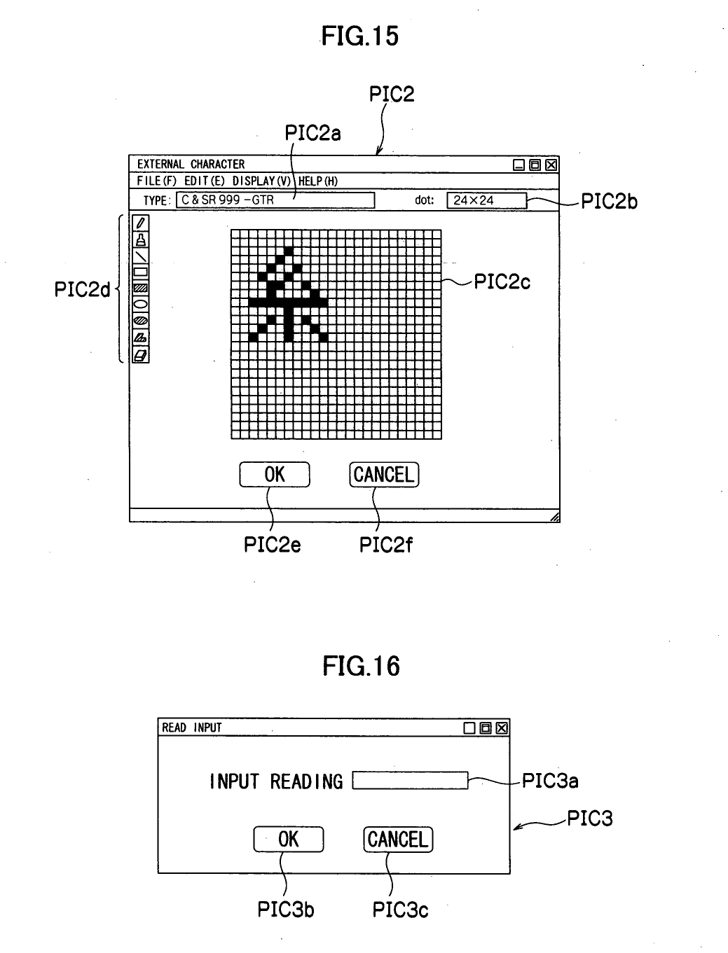

Then, CPU 50a displays an external character input image PIC2 shown in FIG. 15 to cause the user to produce the font of the registration external character (S75). When the external character is registered only in the tape printing apparatus 2, the number of types of the produced font size is equal to the number of types of the font size necessary for the tape printing apparatus 2. When the character information processing apparatus 3 is included as the registration apparatus, the number of types of the produced font size is equal to the number of types of the font size necessary for the character information processing apparatus 3.

The conventional method can be applied as the method for producing the external character having the plurality of types of the font size. For example, when the font having a certain size has been produced and then the font having the next size is produced, the conventional method in which the font having the size to be produced is produced by converting automatically the font having a certain size has been produced into the font having the size to be produced and correcting the converted font can be applied (for example, Japanese Patent Application Laid-Open No. 6-115167).

The external character input image PIC2 includes a display field PIC2a for indicating the registration apparatus, a display field PIC2b for indicating the size of the font in producing, a display area PIC2c for indicating the font in producing, a plurality of production tool icons PIC2d concerning the function of producing the external character such as a dot on/off function, area drawing function, a pattern pointing function, and an eraser function an “OK” icon PIC2e, and a “Cancel” icon PIC2f.

When the “OK” icon PIC2e is operated, basically CPU 50a displays the external character input image PIC2 in order to produce the font having the next size after CPU 50a buffers the information on the font having the size. When the “Cancel” icon PIC2f is operated, basically CPU 50a returns to the display of external character input image PIC2 which is used for the production of the font having the preceding size. When the “Cancel” icon PIC2f is operated during the display of the external character input image PIC2 for producing the font of the first size in the order of the production, CPU 50a returns the display to the registration image PIC1 shown in FIG. 8.

When the “OK” icon PIC2e is operated during the display of the external character input image PIC2 for producing the font of the last size in the order of the production, CPU 50a displays a reading input image PIC3 shown in FIG. 16 and causes the user to input the reading of the external character (S76).

The reading input image PIC3 includes an input field PIC3a, an “OK” icon PIC3b, and a “Cancel” icon PIC3c. When the “Cancel” icon PIC3c is operated, CPU 50a returns the display to the external character input image PIC2 for producing the font of the last size in the order of the production (not shown in FIG. 14).

When the “OK” icon PIC3b of the reading input image PIC3 is operated (it is assumed that the reading is inputted), CPU 50a decides whether (the file of) the character information processing apparatus 3 is specified or not as the registration apparatus (S77). When (the file of) the character information processing apparatus 3 is specified as the registration apparatus, CPU 50a causes the user to select the storage area (for example, by the identification number of the display area PIC1l) (S78) to write the external character information (reading and font), which is buffered and currently produced, in the file (S79). When the external character information is already registered in the storage area, the currently produced external character information overwrites the already registered external character information.

When (the file of) the character information processing apparatus 3 is not specified as the registration apparatus, or when the character information processing apparatus 3 is specified as the registration apparatus and the recording action is finished, CPU 50a decides whether the connected tape printing apparatus 2 is specified as the registration apparatus or not (S80). When the connected tape printing apparatus 2 is specified as the registration apparatus, CPU 50a causes the user to select the storage area (for example, by the identification number of the display area PIC1l) (S81), and CPU 50a transmits the request to write the external character information (reading and font), which is buffered and currently produced, to the tape printing apparatus 2 (S82).

When CPU 50a receives the reply of the end of the process from the tape printing apparatus 2, or when the tape printing apparatus 2 is not the storage apparatus, CPU 50a performs a finishing process such that CPU 50a returns the display to the registration image PIC1, and then CPU 50a ends the series of processes (S83).

In the registration of the external character to the tape printing apparatus 2, when the external character information is already registered in the storage area, the currently produced external character information overwrites the already registered external character information. It is also possible that only the currently produced external character information is transmitted to and stored in the tape printing apparatus 2. It is also possible that all the pieces of external character information concerning the tape printing apparatus 2 including the currently produced external character information is transmitted to and stored in the tape printing apparatus 2. The display of the registration image PIC1 to which CPU 50a returns after the finishing process also includes the currently produced external character information.

While the case in which the “external character” icon PIC1g is operated in the initial image PIC1 is described in FIG. 5, the substantially similar actions are performed when the “File” icon PIC1d, the “Address” icon PIC1e, and the “Name” icon PIC1f are operated.

For example, when the “Address” icon PIC1e is operated, the address in the character information processing apparatus 3 and the address information in the tape printing apparatus 2 are displayed in the display areas PIC1i and PIC1j, and not the “External character edit” icon PIC1r but an “Address edit” icon is displayed at the position of the “External character edit” icon PIC1r. When the “Address edit” icon is operated, after the registration apparatus in which the address information is newly produced or corrected is confirmed, the address input image is displayed, and the address information is newly produced or corrected to register the address information in the specified storage area.

According to the embodiment, the system, the apparatus, and the program for processing the character information, which have high versatility and are applicable to various types of tape printing apparatuses can be provided.

For example, the external character information registered in a certain tape printing apparatus is transferred to and registered in the character information processing apparatus, and the external character information can be registered in other tape printing apparatus. For example, the external character registered in the character information processing apparatus can be registered in each of the plurality of tape printing apparatuses whose types are different from one another. For example, the character information processing apparatus can produce the external character for the tape printing apparatus. In addition to the external character registration function, the same can apply to other registration functions such as the file registration function, the address registration function, and the name registration function which are included in the tape printing apparatus.

In the registration in the character information processing apparatus, since the registration can be performed as the file, the registration contents can be managed in each tape printing apparatus by providing the registration file in each product of the tape printing apparatus.

Since the external character registration function, the file registration function, the address registration function, and the name registration function have the same initial registration image, the user can perform the operation in the similar procedure, and the user easily learns the operating procedure. Since the operating procedure is standardized, the operation can be easily performed.

### (B) Other Embodiments

While various modifications of the invention are described in the embodiment, further modifications of the invention can be cited as an example.

In the above-described embodiment, the small print producing apparatus connected to the character information processing apparatus is shown as the tape printing apparatus. However, it is also possible that the character information processing apparatus is connected to a stamp (seal) producing apparatus, or it is also possible that the character information processing apparatus similarly deals with the tape printing apparatus and the stamp producing apparatus without distinguishing the tape printing apparatus from the stamp producing apparatus.

In the above-described embodiment, before the external character is produced, the registration apparatus of the produced external character is specified. However, it is possible that the registration apparatus of the produced external character is specified after the external character is produced or after the reading of the external character is inputted. In this case, it is possible to produce the fonts of all the sizes independently of the connected tape printing apparatus. It is also possible that the character information processing apparatus produces the font corresponding to the connected tape printing apparatus and specifies the connected tape printing apparatus and then the specified tape printing apparatus produces the font which is lacking in the tape printing apparatus. The timing of specification of the storage area of the registration apparatus is not limited to the post-production of the external character font described in the embodiment, and it is possible to specify the storage area of the registration apparatus before the external character font is produced.

It is possible that the character information processing apparatus is always included as the registration apparatus of the produced external character and the user specifies only whether the produced external character is registered in the tape printing apparatus or not. It is possible that only the character information processing apparatus is set as the registration apparatus of the produced external character and the copy function of the character information processing apparatus performs the registration of the produced external character into the tape printing apparatus.

In the above-described embodiment, the transmission and reception of the registration external character information can be performed by the copy function between the character information processing apparatus and the tape printing apparatus. However, it is also possible to permit a movement function. It is also possible that the character information processing apparatus can delete the registration external character information of the tape printing apparatus.

In the above-described embodiment, the transmission and reception (copy or movement) of each one piece of registration external character information can be performed between the character information processing apparatus and the tape printing apparatus. However, it is also possible to specify the plurality of pieces of registration external character information to transmit and receive the pieces of registration external character information in a collective way.

In the initial registration direction when the number of external characters exceeds the upper limit number of the registration external characters which is permitted in tape printing apparatus, it is possible that the character information processing apparatus automatically produces the registration external character file concerning the tape printing apparatus to save and register the external characters exceeding the upper limit number (for example, the oldest registration external character or the registration external character specified by the user) in the automatically produced registration external character file.

It is possible that the character information processing apparatus is simultaneously connected to the two tape printing apparatuses to act as a relay function when the registration external character of the first tape printing apparatus is registered in the second tape printing apparatus by moving or copying the registration external character of the first tape printing apparatus to the second tape printing apparatus. In this case, the display area PIC1i in FIG. 5 becomes the display area of the registration external character information of one of the tape printing apparatuses, the display area PIC1l becomes the display area of the registration external character information of the other tape printing apparatus, and the process can be performed in the substantially same way as the embodiment. When the two tape printing apparatuses are different from each other in the combination of the font sizes, the character information processing apparatus automatically generates the font of the size which is lacking in the tape printing apparatus.

In the above-described embodiment, the character information processing apparatus takes the initiative in transmitting and receiving the registration external character information between the character information processing apparatus and the tape printing apparatus. However, it is possible that the tape printing apparatus takes the initiative in transmitting and receiving the registration external character information between the character information processing apparatus and the tape printing apparatus.

In the above-described embodiment, the character information processing apparatus 3 stores the information on all the types of font sizes of the external character. However, it is possible that the character information processing apparatus stores a part of the types of font sizes.

The modifications of the external character registration function of the invention which can be applied to the file registration function, the address registration function, and the name registration function are adapted to be formed in the modifications concerning each function.

1. A character information processing system in which a small print producing apparatus and a character information processing apparatus are connected while data can be transmitted and received,
wherein the character information processing apparatus comprises:
registration data capturing means for capturing one or a plurality of predetermined types of registration data from the small print producing apparatus;
registration data supplying means for supplying the plurality of predetermined types of registration data to the small print producing apparatus to register the plurality of predetermined types of registration data; and
first registration data producing means for newly producing the plurality of predetermined types of registration data or correcting the plurality of predetermined types of registration data,
the small print producing apparatus comprises:
second registration data producing means for newly producing the plurality of predetermined types of registration data or correcting the plurality of predetermined types of registration data;
registration data providing means for replying the plurality of predetermined types of registration data stored in the small print producing apparatus in accordance with a request from the registration data capturing means; and
reception data registering means for registering the plurality of predetermined types of registration data supplied by the registration data supplying means in the small print producing apparatus.

2. A character information processing apparatus which is connected to a small print producing apparatus while data can be transmitted and received, the apparatus comprising:
registration data capturing means for capturing one or a plurality of predetermined types of registration data from the small print producing apparatus;
registration data supplying means for supplying the plurality of predetermined types of registration data to the small print producing apparatus to register the plurality of predetermined types of registration data; and
registration data producing means for newly producing the plurality of predetermined types of registration data or correcting the plurality of predetermined types of registration data.

3. A character information processing apparatus according to claim 2, further comprising:
registration data storing means for internally storing the plurality of predetermined types of registration data;
image displaying means for displaying the plurality of predetermined types of registration data captured from the small print producing apparatus by the registration data capturing means and the plurality of predetermined types of registration data stored in the registration data storing means on the same display image, and
registration apparatus changeable means for moving or copying the plurality of predetermined types of registration data captured from the small print producing apparatus to the registration data storing means in accordance with a first operation input performed to the display image, and registering the plurality of predetermined types of registration data stored in the registration data storing means in accordance with a second operation input performed to the display image by copy-supplying or move-supplying the plurality of predetermined types of registration data to the small print producing apparatus by the registration data supplying means.

4. A character information processing program which is loaded in a computer connected to a small print producing apparatus while data can be transmitted and received, the program comprising:
a registration data capturing function unit which captures one or a plurality of predetermined types of registration data from the small print producing apparatus;
a registration data supplying function unit which supplies the plurality of predetermined types of registration data to the small print producing apparatus to register the plurality of predetermined types of registration data; and
a registration data producing function unit which newly produces the plurality of predetermined types of registration data or correcting the plurality of predetermined types of registration data.

5. A character information processing program according to claim 4, further comprising:
a registration data storing function unit which internally stores the plurality of predetermined types of registration data;
an image displaying function unit which displays the plurality of predetermined types of registration data captured from the small print producing apparatus by the registration data capturing function unit and the plurality of predetermined types of registration data stored in the registration data storing function unit on the same display image, and
a registration apparatus changeable function unit which moves or copies the plurality of predetermined types of registration data captured from the small print producing apparatus to the registration data storing function unit in accordance with a first operation input performed to the display image, and registers the plurality of predetermined types of registration data stored in the registration data storing function unit in accordance with a second operation input performed to the display image by copy-supplying or move-supplying the plurality of predetermined types of registration data to the small print producing apparatus by the registration data supplying function unit.
